(19) United States
(12) Patent Application Publication
(10) Pub. No.: US 2015/0119011 A1
(43) Pub. Date: Apr. 30, 2015

(54) INFORMATION PROCESSING METHOD AND DEVICE

(71) Applicants: Lenovo (Beijing) Co., Ltd., Beijing (CN); Beijing Lenovo Software Ltd., Beijing (CN)

(72) Inventor: Li Chen, Beijing (CN)

(73) Assignees: Lenovo (Beijing) Co., Ltd., Beijing (CN); Beijing Lenovo Software Ltd., Beijing (CN)

(21) Appl. No.: 14/229,213

(22) Filed: Mar. 28, 2014

(30) Foreign Application Priority Data
Oct. 30, 2013 (CN) 201310529085.8

(51) Int. Cl. H04M 3/42; H04M 3/54

(52) U.S. Cl. CPC H04M 3/42348; H04M 3/543
USPC 455/417

(57) ABSTRACT

Information processing method and device applied to a first electronic device are disclosed. The first electronic device can establish a communication connection with a second electronic device, and the method includes: judging whether a communication between the first electronic device and the second electronic device meets a preset condition to obtain a first judgment result; and in a case where the first judgment result indicates that the communication between the first electronic device and the second electronic device does not meet the preset condition, obtaining a second communication address of the second electronic device and obtaining a third communication address of a third electronic device, where the third electronic device can establish a communication connection with the second electronic device such that a communication connection can be established between the second electronic device and the third electronic device based on the second communication address and/or the third communication address.

The present application claims the priority to Chinese Patent Application No. 201310529085.8, entitled “INFORMATION PROCESSING METHOD AND DEVICE”, filed on Oct. 30, 2013 with the Chinese State Intellectual Property Office, which is incorporated herein by reference in its entirety.

### FIELD

The present disclosure relates to the field of electronic technology, and in particular to an information processing method and electronic device.

### BACKGROUND

With the rapid development of electronic technology, functions of various electronic devices are more and more plentiful and humanized, and users have better experience in using the electronic devices. Taking a mobile phone as an example, the current smart phone has been improved into a small computer in addition to keeping the basic calling function. The current smart phone has not only powerful storage space but also various kinds of installable software, and various functions of the mobile phone are more and more fine and humanized.

In order to guarantee that every incoming call is not missing for the user, a call forwarding function is added to the conversation mode of the mobile phone. A telephone number to which a call is forwarded is preset in the mobile phone, and when the mobile phone receives an incoming call which is not answered for a preset time period, the call is forwarded to the preset mobile phone. However, it is found that a call is forwarded based on a preset telephone number in the existing call forwarding solution, and the user can answer the incoming call after the call is forwarded only if the mobile phone of the preset telephone number is beside the user. But in practice application, it is impractical that a user carries more than two communication devices such as mobile phones, and the user may miss the incoming call if the user resets the telephone number to which the call is forwarded during the incoming call.

Therefore, the telephone number to which a call is forwarded is fixed to some extent in the existing call forwarding solution, and the call or conversation can not be forwarded to a desired mobile phone in real time in accordance with actual application scenario during the call or conversation. Accordingly, in the existing call forwarding solution, an address of a communication device selected by a user can not be obtained in real time to conduct the call or conversation forwarding.

### SUMMARY

An information processing method and device are provided according to embodiments of the disclosure, to solve the technical problem that an address of a communication device selected by a user can not be obtained in real time to conduct call forwarding or conversation forwarding.

In one aspect, an information processing method is provided according to an embodiment of the disclosure. The method is applied to a first electronic device, the first electronic device is capable of establishing a communication connection with a second electronic device. The method includes:

judging whether a communication between the first electronic device and the second electronic device meets a preset condition to obtain a first judgment result; and

obtaining a second communication address of the second electronic device and obtaining a third communication address of a third electronic device in a case where the first judgment result indicates that the communication between the first electronic device and the second electronic device does not meet the preset condition, where the third electronic device is capable of establishing a communication connection with the second electronic device such that a communication connection is capable of being established between the second electronic device and the third electronic device based on the second communication address and/or the third communication address.

Optionally, the judging whether a communication between the first electronic device and the second electronic device meets a preset condition to obtain the first judgment result may include: detecting whether a current electric quantity of the first electronic device is lower than a threshold to obtain a first detection result; and obtaining the first judgment result based on the first detection result, where in a case where the first detection result indicates that the current electric quantity is lower than the threshold, the first judgment result indicates that the communication between the first electronic device and the second electronic device does not meet the preset condition.

Optionally, the judging whether a communication between the first electronic device and the second electronic device meets a preset condition to obtain the first judgment result may include: detecting whether a first operation input by a user is obtained in the first electronic device to obtain a second detection result, where the first operation is used to cause the first electronic device to forward the communication connection between the first electronic device and the second electronic device; and obtaining the first judgment result based on the second detection result, where in a case where the second detection result indicates that the first operation is received, the first judgment result indicates that the communication between the first electronic device and the second electronic device does not meet the preset condition.

Optionally, the first electronic device may include a near-field wireless communication module, and the obtaining a third communication address of a third electronic device in a case where the communication between the first electronic device and the second electronic device does not meet the preset condition may include: searching for, by the near-field wireless communication module, the third electronic device whose distance from the first electronic device is less than a preset distance in a case where the first judgment result indicates that the communication between the first electronic device and the second electronic device does not meet the preset condition; and establishing a paired connection with the third electronic device and obtaining the third communication address of the third electronic device after the third electronic device is found.

Optionally, the method may further include, after the obtaining a second communication address of the second electronic device and obtaining a third communication address of a third electronic device, transmitting the third communication address to the second electronic device such that the second electronic device is capable of transmitting a second communication request to the third electronic device based on the third communication address to establish a communication connection with the third electronic device.

Optionally, the method may further include, after the obtaining a second communication address of the second electronic device and obtaining a third communication address of a third electronic device, transmitting the second communication address to the third electronic device such that the third electronic device is capable of transmitting a third communication request to the second electronic device based on the second communication address to establish a communication connection with the second electronic device.

Optionally, the method may further include, after the obtaining a second communication address of the second electronic device and obtaining a third communication address of a third electronic device, transmitting the second communication address and the third communication address to a fourth electronic device such that the fourth electronic device is capable of establishing a communication connection between the second electronic device and the third electronic device based on the second communication address and the third communication address.

Optionally, the method may further include, in a case where a communication connection is established between the first electronic device and the second electronic device over a first communication network and after the obtaining a second communication address of the second electronic device and obtaining a third communication address of a third electronic device, connecting the third electronic device to the first communication network based on the third communication address such that the third electronic device, the second electronic device and the first electronic device are capable of being simultaneously connected to the first communication network while the first electronic device keeps communicating.

Optionally, the method may further include, in a case where the first electronic device communicates with the second electronic device over a first communication channel and after the obtaining a second communication address of the second electronic device and obtaining a third communication address of a third electronic device, disconnecting the first electronic device from the first communication channel; and connecting the third electronic device to the first communication channel based on the third communication address such that the third electronic device is capable of communicating with the second electronic device over the first communication channel.

In another aspect, an information processing electronic device is provided according to an embodiment of the disclosure. The information processing electronic device is applied to a first electronic device, and the first electronic device is capable of establishing a communication connection with a second electronic device. The information processing electronic device includes:

a judging unit adapted to judge whether a communication between the first electronic device and the second electronic device meets a preset condition to obtain a first judgment result; and

an obtaining unit adapted to obtain a second communication address of the second electronic device and obtain a third communication address of a third electronic device in a case where the first judgment result indicates that the communication between the first electronic device and the second electronic device does not meet the preset condition, where the third electronic device is capable of establishing a communication connection with the second electronic device such that a communication connection is capable of being established between the second electronic device and the third electronic device based on the second communication address and/or the third communication address.

Optionally, the judging unit may include: a first detection unit adapted to detect whether a current electric quantity of the first electronic device is lower than a threshold to obtain a first detection result; and a first obtaining sub-unit adapted to obtain the first judgment result based on the first detection result, where in a case where the first detection result indicates that the current electric quantity is lower than the threshold, the first judgment result indicates that the communication between the first electronic device and the second electronic device does not meet the preset condition.

Optionally, the judging unit may include: a second detection unit adapted to detect whether a first operation input by a user is obtained in the first electronic device to obtain a second detection result, where the first operation is used to cause the first electronic device to forward the communication connection between the first electronic device and the second electronic device; and a second obtaining sub-unit adapted to obtain the first judgment result based on the second detection result, where in a case where the second detection result indicates that the first operation is received, the first judgment result indicates that the communication between the first electronic device and the second electronic device does not meet the preset condition.

Optionally, the first electronic device may include a near-field wireless communication module, and the obtaining unit may include: a searching unit adapted to search for, by the near-field wireless communication module, the third electronic device whose distance from the first electronic device is less than a preset distance in a case where the communication between the first electronic device and the second electronic device does not meet the preset condition; and a third obtaining sub-unit adapted to establish a paired connection with the third electronic device and obtain the third communication address of the third electronic device after the third electronic device is found.

Optionally, the obtaining unit may be adapted to transmit the third communication address to the second electronic device such that the second electronic device is capable of transmitting a second communication request to the third electronic device based on the third communication address to establish a communication connection with the third electronic device.

Optionally, the obtaining unit may be adapted to transmit the second communication address to the third electronic device such that the third electronic device is capable of transmitting a third communication request to the second electronic device based on the second communication address to establish a communication connection with the second electronic device.

Optionally, the obtaining unit may be adapted to transmit the second communication address and the third communication address to a fourth electronic device such that the fourth electronic device is capable of establishing a communication connection between the second electronic device and the third electronic device based on the second communication address and the third communication address.

Optionally, in a case where a communication connection is established between the first electronic device and the second electronic device over a first communication network, the obtaining unit may be adapted to connect the third electronic device to the first communication network based on the third communication address such that the third electronic device, the second electronic device and the first electronic device are capable of being simultaneously connected to the first communication network while the first electronic device keeps communicating.

Optionally, in a case where the first electronic device communicates with the second electronic device over a first communication channel, the obtaining unit may include: a disconnecting unit adapted to disconnect the first electronic device from the first communication channel; and a connecting unit adapted to connect the third electronic device to the first communication channel based on the third communication address such that the third electronic device is capable of communicating with the second electronic device over the first communication channel.

There are at least the following technical effects or advantages in the one or more technical solutions of embodiments of the disclosure.

(1) In the embodiment of the disclosure, a target communication address may be obtained on the spot. When it is judged that the communication between the first electronic device and the second electronic device does not meet a preset condition, communication addresses of the second electronic device and the third electronic device may be obtained such that a communication connection is capable of being established between the second electronic device and the third electronic device. In this way, the technical problem that it is unable to flexibly select an object to which the call or the conversation is forwarded in the prior art is solved. In addition, the call forwarding or conversation forwarding may be flexibly performed based on the address selected by the user, whether in the call requesting process or in the conversation process.

(2) In the embodiment of the disclosure, if the communication condition is not met between the first electronic device and the second electronic device, a communication address of a third electronic device in proximity to the first electronic device is obtained in time by a near-field wireless communication module, such that the second electronic device is capable of communicating with the third electronic device based on the communication address of the third electronic device, and the call between first electronic device and the second electronic device is forwarded to be between the second electronic device and the third electronic device. In this way, the technical problem in the existing call forwarding solution that it is unable to obtain in real time an address of a communication device selected by a user to perform the call forwarding or conversation forwarding is solved, and a call may be forwarded to any electronic device selected by the user as desired.

(3) In the embodiment of the disclosure, interaction is provided between the first electronic device and the third electronic device during the call forwarding, and the state of the third electronic device is detected before the third communication address is obtained. In this way, an optimum third electronic device on which the call forwarding or conversation forwarding is capable of being performed may be obtained, and stability and robustness of the communication after the conversation forwarding may be increased.

### BRIEF DESCRIPTION OF THE DRAWINGS

FIG. 1 is a flow chart of an information processing method according to an embodiment of the disclosure;

FIG. 2 is a flow chart of forwarding a call between a first mobile phone and a second mobile phone to be between the second mobile phone and a third mobile phone according to an embodiment of the disclosure; and

FIG. 3 is a schematic structural diagram of an information processing device according to an embodiment of the disclosure.

### DETAILED DESCRIPTION

In an embodiment of the disclosure, an information processing method and an information processing device are provided to solve the technical problem in existing call forwarding solution that an address of a communication device selected by a user can not be obtained in real time to conduct a call or conversation forwarding.

In view of the above, technical solutions are provided in embodiments of the disclosure based on the following general idea.

An information processing method is provided. The information processing method is applied to a first electronic device, and the first electronic device is capable of establishing a communication connection with a second electronic device. The method includes:

judging whether a communication between the first electronic device and the second electronic device meets a preset condition, to obtain a first judgment result; and in a case where the first judgment result indicates that the communication between the first electronic device and the second electronic device does not meet the preset condition, obtaining a second communication address of the second electronic device and obtaining a third communication address of a third electronic device, where the third electronic device is capable of establishing a communication connection with the second electronic device such that a communication connection is capable of being established between the second electronic device and the third electronic device based on the second communication address and/or the third communication address.

In view of the above, in the embodiment of the disclosure, if it is judged that the communication between the first electronic device and the second electronic device does not meet the preset condition, a communication address of the second electronic device and a communication address of a third electronic device are obtained such that a communication connection is capable of being established between the second electronic device and the third electronic device. The conventional technical problem that the object to which the call or conversation is forwarded can not be selected flexibly is solved, and the call or conversation can be forwarded flexibly in accordance with an address selected by a user during the call request or the conversation.

In order to understand the above technical solution better, the above technical solution will be described in detail below in conjunction with accompanying drawings and specific embodiments. It should be understood that the embodiments of the disclosure and the specific features therein are used to describe the technical solution of the disclosure in detail, but do not intend to limit the technical solution of the disclosure, and the embodiments of the disclosure and the technical features therein can be combined with each other without if there is no conflict.

It is to be noted that the term “and/or” appeared herein is merely association relationship describing association objects, and indicates that there are three types of relationships. For example, A and/or B may indicate three cases: there is only A, there are both A and B, or there is only B. In addition, character “/” herein generally indicates that the former and latter association objects have “or” relationship.

The information processing method provided in the embodiment of the disclosure may be applied in an environment that two electronic devices are going to communicate or are communicating over a communication network, and such device may be a mobile phone, a fixed line phone, or other smart device with a communication function such as a tablet computer, a laptop, a smart phone, a PDA (Personal Digital Assistant). Hereinafter, by taking a communication between the most common mobile phones as an example in an embodiment of the disclosure. When a mobile phone A initiates a call request to a mobile phone B or when the mobile phone A and the mobile phone B are in conversation, the mobile phone B may adopt the information processing method provided in the embodiment of the disclosure to obtain the telephone number of a mobile phone C, establish a communication between the mobile phone A and the mobile phone C, while the mobile phone B may continue to keep communicating or disconnect from the communication. It is also to be noted that, “call forwarding” and “conversation forwarding” referred in the following embodiments of the disclosure both refer to forwarding the communication between the mobile phone A and the mobile phone B to be between the mobile phone A and the mobile phone C or extending the communication between the mobile phone A and the mobile phone B to be among the mobile phone A, the mobile phone B and the mobile phone C. The “call forwarding” occurs before the conversation between the mobile phone A and the mobile phone B, and the “conversation forwarding” occurs during the conversation between the mobile phone A and the mobile phone B.

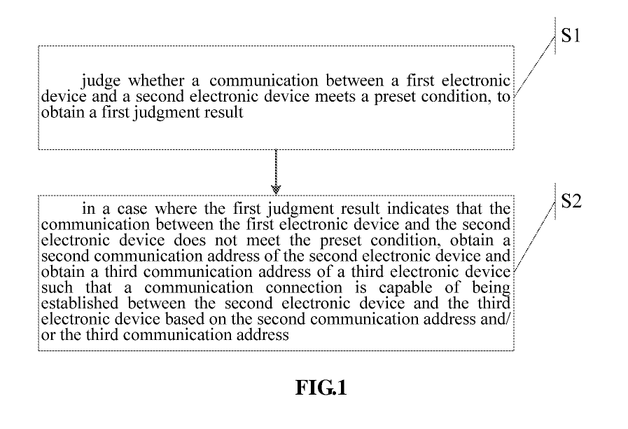

As shown in FIG. 1, an information processing method is provided according to an embodiment of the disclosure. The information processing method includes steps S1 and S2.

Step S1 is judging whether a communication between a first electronic device and a second electronic device meets a preset condition, to obtain a first judgment result.

In an implementation, when the second electronic device initiates a communication request to the first electronic device, the first electronic device judges whether it meets the preset condition for communicating with the second electronic device to obtain the first judgment result; or during the communication between the first electronic device and the second electronic device, the first electronic device periodically judges whether it meets the preset condition to obtain the first judgment result, for example, the first electronic device performs the judgment every 10 minutes. In a case where the first judgment result indicates the first electronic device does not meet the preset condition, step S2 is performed to forward the communication to be between the second electronic device and a third electronic device.

The preset condition in step S1 is described below by way of two embodiments.

Step S1 may include:

detecting whether the electric quantity of the first electronic device is lower than a threshold, to obtain a first detection result; and

obtaining the first judgment result based on the first detection result, where in a case where the first detection result indicates that the electric quantity is lower than the threshold, the first judgment result indicates that the communication between the first electronic device and the second electronic device does not meet the preset condition.

In a first embodiment, the preset condition is the electric quantity of the first electronic device is lower than a threshold.

In an implementation, when receiving a call request sent from the second electronic device, the first electronic device detects its electric quantity, or during the communication between the first electronic device and the second electronic device, the first electronic device periodically judges the electric quantity, to obtain a first detection result. The system obtains the first judgment result based on the first detection result. In a case where the first detection result indicates that the electric quantity of the first electronic device is lower than a threshold, the obtained first judgment result indicates that at this time the first electronic device does not meet the preset condition for receiving a call request initiated by the second electronic device, or the first electronic device does not meet the preset condition for continuing communicating with the second electronic device. Taking a mobile phone as an example, if the first mobile phone detects that it's electric quantity is insufficient during receiving an incoming call request from a second mobile phone, it is regarded as that the condition for answering this incoming call is not met, and it may prompt the user of whether to forward this incoming call to a third mobile phone, or forward this incoming call automatically.

Alternatively, step S1 may include:

detecting whether a first operation input by a user is obtained in the first electronic device, to obtain a second detection result, where the first operation is used to cause the first electronic device to forward the communication connection between the first electronic device and the second electronic device;

obtaining the first judgment result based on the second detection result, where in a case where the second detection result indicates that the first operation is received, the first judgment result indicates that the communication between the first electronic device and the second electronic device does not meet the preset condition.

In a second embodiment, the preset condition refers to disconnecting the communication between the first electronic device and the second electronic device in accordance with a user's operation.

In an implementation, when the first electronic device receives a call request sent from the second electronic device and the user does not want to use the first electronic device to communicate with the second electronic device, or when the user does not want to continue to use the first electronic device to communicate with the second electronic device during the communication between the first electronic device and the second electronic device, the user may input a first operation indicating not establishing or no longer establishing the communication between the first electronic device and the second electronic device. For example, the first operation may be a forwarding operation for the current communication by pressing a preset key. If the second detection result obtained by the first electronic device indicates that there is the first operation input by a user, the first judgment result obtained based on the second detection result indicates that the communication between the first electronic device and the second electronic device does not meet the preset condition.

The cases of the above two embodiments that do not meet the preset condition may be the case that the electric quantity of the first electronic device is insufficient to support the communication with the second electronic device, or may be the case that the user does not want to establish the communication between the first electronic device and the second electronic device. In the two cases, after step S2 is performed, the communication between the first electronic device and the second electronic device may be forwarded to be between the second electronic device and the third electronic device. In the embodiments of the disclosure, if the first electronic device does not meet the preset condition, it is not limited to forwarding the communication directly. If the first electronic device does not meet the preset condition, the communication objects may not be limited to the first electronic device and the second electronic device, and a third electronic device may be added into the communication with the first electronic device not disconnected from the communication if the user wants to add the third electronic device into the communication to make the communication objects be three.

Step S2 is obtaining a second communication address of the second electronic device and obtaining a third communication address of a third electronic device in a case where the first judgment result indicates that the communication between the first electronic device and the second electronic device does not meet the preset condition, where the third electronic device is capable of establishing a communication connection with the second electronic device such that a communication connection is capable of being established between the second electronic device and the third electronic device based on the second communication address and/or the third communication address.

In an implementation, after step S1 is performed, the communication between the first electronic device and the second electronic device needs to be forwarded to be between the second electronic device and a third electronic device or a third electronic device needs to be added into the communication between the first electronic device and the second electronic device if the obtained first judgment result indicates that the communication between the first electronic device and the second electronic device does not meet the preset condition. In this case, step S2 of obtaining the second communication address of the second electronic device and the third communication address of the third electronic device such that a communication connection is capable of being established between the second electronic device and the third electronic device based on the second communication address and/or the third communication address, is performed.

If the first electronic device disconnects the communication with the second electronic device when the second electronic device and the third electronic device establish a communication, the communication between the first electronic device and the second electronic device is forwarded to be between the second electronic device and the third electronic device. If the first electronic device continues to keep the communication with the second electronic device during the communication between the second electronic device and the third electronic device, the communication is among the three electronic devices. More electronic devices may be added into the communication to achieve the conversation among multiple electronic devices. For example, in one implementation, the first electronic device receives communication information of the third electronic device, integrates the communication information of the third electronic device and communication information of the first electronic device itself, and transmits the integrated communication information to the second electronic device, thus the communication is conduct on the existing communication channel which saves communication bandwidth, and reconnection is not needed which speeds up the constructing of three-parties or multiple-parties communication and the established communication is not affected. In another implementation, the communication network among the first electronic device, the second electronic device and the third electronic device is construct by a fourth electronic device to achieve three-parties communication. If the first electronic device connects with the second electronic device and the third electronic device respectively, the first electronic device only acts as a bridge in the communication between the second electronic device and the third electronic device. For example, the first electronic device acts as a WiFi device and only provides connection for the communication between the second electronic device and the third electronic device. In this case, the first electronic device transmits communication information of the third electronic device to the second electronic device after receiving the communication information. The third electronic device may employ the existing communication channel between the first electronic device and the second electronic device to communicate and the communication connection is established quickly, while the first electronic device is not affected to make activities other than communication such as take photos or play games. The communication information herein may include audio information, and medium information such as video, picture and text.

The first electronic device can obtain the second communication address of the second electronic device when the second electronic device initiates a call request to the first electronic device or during the communication between the second electronic device and the first electronic device. The way for obtaining the third communication address of the third electronic device in step S2 will be described below.

The first electronic device may include a near-field wireless communication module, and the obtaining the third communication address of the third electronic device in a case where the communication between the first electronic device and the second electronic device does not meet the preset condition may include:

searching for a third electronic device whose distance from the first electronic device is less than a preset distance by the near-field wireless communication module in a case where the first judgment result indicates that the communication between the first electronic device and the second electronic device does not meet the preset condition; and

establishing a paired connection with the third electronic device and obtaining the third communication address of the third electronic device after the third electronic device is found.

### Third Embodiment

The first electronic device provided in the embodiment of the disclosure includes a near-field wireless communication module. The first electronic device may acquire information of surrounding electronic device within a preset distance in real time by using the near-field wireless communication module when the communication between the first electronic device and the second electronic device does not meet the preset condition. In the embodiment of the disclosure, the near-field wireless communication module is not limited and may be a near-field communication module such as a NFC module, a Bluetooth module, an infrared module, a BT module, a sound module and a vibration module. The first electronic device may search for surrounding third electronic devices within a preset distance such as 10 meters in time by using the near-field wireless communication module, and select the most appropriate electronic device from these electronic devices as the third electronic device. For example, the first electronic device may firstly establish paired connections with these electronic devices, obtain information of these electronic devices such as whether the electric quantity reaches the threshold or whether the electronic device is communicating with other electronic device, to select the most appropriate electronic device as the third electronic device, and obtain the communication address of the electronic device as the third communication address. In the embodiment of the disclosure, for triggering acquiring the third communication address of the third electronic device by using the near-field wireless communication module, the user may “shake” or “swing” the first electronic device to complete the searching and matching process and thus to obtain the third communication address, or the user may select the third electronic device firstly, and then select and obtain the third communication address by making the first electronic device “touch” the third electronic device.

Therefore, in the embodiment of the disclosure, since an electronic device nearby the user is acquired in real time and used as the third electronic device by using the near-field wireless communication module, the effect of finding and obtaining a new communication address quickly is achieved, which improves user experience.

### Fourth Embodiment

Except that the communication address of the third electronic device may be acquired in real time by using the near-field wireless communication module as described in the above third embodiment, the third communication address may be from the address list of the first electronic device. For example, during the conversation between the first mobile phone and the second mobile phone, a telephone number may be selected from the contacts address list by the first mobile phone to be used as the third communication address, so that the second mobile phone and the third mobile phone may initiate a call request to each other, and thus the conversation may be forwarded to a remote user mobile phone.

After the second communication address of the second electronic device and the third communication address of the third electronic device are obtained, step S2 is performed, so that the second electronic device and the third electronic device may establish a communication based on the second communication address and/or the third communication address.

In addition, the method may further includes, after the obtaining the second communication address of the second electronic device and obtaining the third communication address of the third electronic device,

transmitting the third communication address to the second electronic device such that the second electronic device is capable of transmitting a second communication request to the third electronic device based on the third communication address, to establish a communication connection with the third electronic device.

### Fifth Embodiment

In the embodiment, the first electronic device transmits the third communication address to the second electronic device such that the second electronic device is capable of transmitting the second communication request to the third electronic device based on the third communication address, to establish a communication connection between the second electronic device and the third electronic device. For example, after obtaining the number of the third mobile phone, the first mobile phone transmits the number of the third mobile phone to the second mobile phone or a base station between the first mobile phone and the second mobile phone, such that the second mobile phone or the base station may dial the third mobile phone based on the number of the third mobile phone, to achieve the communication between the second mobile phone and the third mobile phone.

It can be seen from the above first to fifth embodiments that, the communication address of the third electronic device nearby the first electronic device is obtained in real time by using a near-field wireless communication module if the first electronic device does not meet the condition for communicating with the second electronic device, to allow the communication between the second electronic device and the third electronic device based on the communication address of the third electronic device, and the call between the first electronic device and the second electronic device is forwarded to be between the first electronic device and the third electronic device. Therefore, the technical problem of the existing call forwarding solution that the address of the communication device selected by the user can not be obtained in real time to conduct the call forwarding is solved, and a call may be forwarded to any electronic device selected by the user as desired.

For better understanding of the solution in the embodiment of the present disclosure, the process of forwarding the call between the first and the second mobile phone to be between the second mobile phone and the third mobile phone will be described hereinafter by a specific application scene.

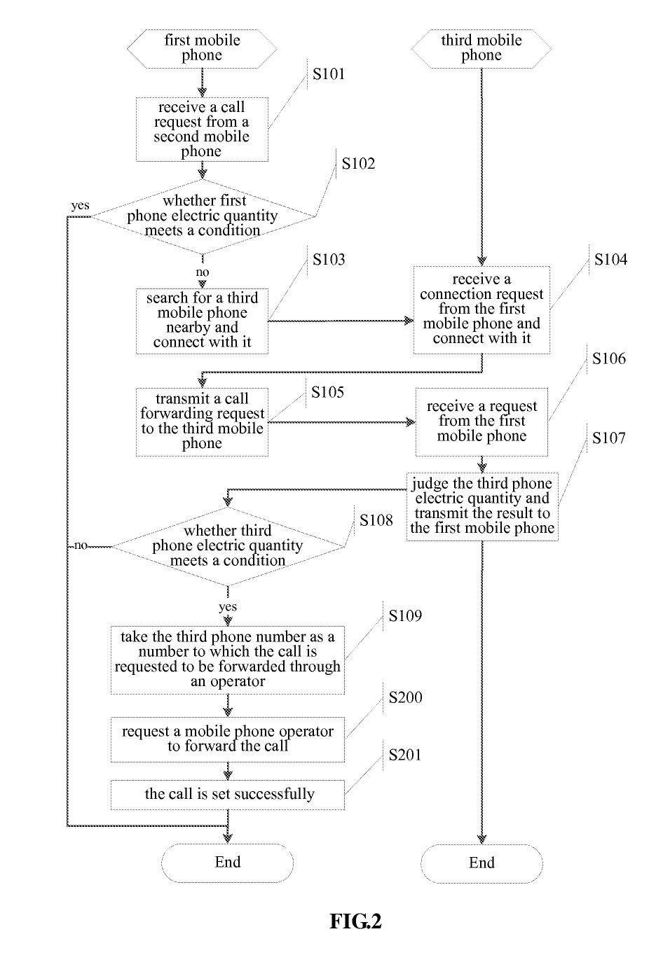

As shown in FIG. 2, when the first mobile phone receives a call request from the second mobile phone as described in step S101 (or the moment of step S101 may be a moment that the first mobile phone is communicating with the second mobile phone), the first mobile phone judges whether the electric quantity meets the first threshold in step S102 (the judgment condition in step S102 may be whether a negative operation input by a user is obtained). If the electric quantity does not meet the threshold, step S103 is performed, where the first mobile phone searches for a surrounding third mobile phone by using a near-field wireless communication module. In FIG. 2, step S104, S106 and S107 are all performed by the third mobile phone. After the third mobile phone receives a connection request from the first mobile phone and establishes a connection with the first mobile phone in step S104, the first mobile phone performs step S105 in which a call forwarding request is transmitted to the third mobile phone. After the third mobile phone receives the request from the first mobile phone in step S106 and if the request is agreed, step S107 is performed in which the electric quantity of the third mobile phone itself is detected (or whether the third mobile phone itself is communicating with other device is detected) and the detection result is transmitted to the first mobile phone. After the first mobile phone obtains the detection result from the third mobile phone, step S108 is performed to judge whether the electric quantity of the third mobile phone meets the communication condition. If the communication condition is met, step S109 is performed to take the number of the third mobile phone as the number to which the call is requested to be forwarded through the operator, and step S200 is performed at the same time to request the operator to forward the call. Then step S210 is performed in which the call forwarding is successfully set and the process ends.

It can be seen from the embodiment of the disclosure that an interaction solution is provided for the first electronic device and the third electronic device during the call forwarding procedure and the condition of the third electronic device is detected before the third communication address is obtained, therefore, an optimum third electronic device for call forwarding or conversation forwarding can be obtained, which improves the stability and robustness of the communication after the call is forwarded.

In addition, the method may further include, after the obtaining the second communication address of the second electronic device and obtaining the third communication address of the third electronic device,

transmitting the second communication address to the third electronic device such that the third electronic device is capable of transmitting a third communication request to the second electronic device based on the second communication address to establish a communication connection with the second electronic device.

### Sixth Embodiment

In the embodiment, the first electronic device transmits the second communication address to the third electronic device such that the third electronic device is capable of transmitting a third communication request to the second electronic device based on the second communication address, to establish a communication connection between the second electronic device and the third electronic device. For the above example, the first mobile phone transmits the number of the second mobile phone to the third mobile phone such that the third mobile phone dials back to the second mobile phone based on this number, to achieve the communication between the third mobile phone and the second mobile.

In an implementation, in step S2, the first electronic device may transmit preset command information to the second electronic device and/or the third electronic device besides transmitting the obtained second communication address to the third electronic device and transmitting the obtained third communication address to the second electronic device, such that the second electronic device and/or the third electronic device may establish a connection rapidly based on the preset command information. For example, the first electronic device may transmit command information such as “Please initiate a call request based on the communication address” along with the second communication address to the third electronic device. Meanwhile, the first electronic device may transmit command information such as “hung up”, “wait” or “answer the call based on the third communication address directly” to the second electronic device such that the second electronic device may get ready for answering the call before receiving the call request from the third electronic device. Therefore, the call is directly answered without user operation after the call request from the third electronic device is received, which achieves a rapid call forwarding and improves user experience.

It can be seen that, since the command information is sent along with the communication address, the call forwarding/conversation forwarding is achieved more rapidly.

In addition, the method may further include, after the obtaining the second communication address of the second electronic device and obtaining the third communication address of the third electronic device,

transmitting the second communication address and the third communication address to a fourth electronic device such that the fourth electronic device is capable of establishing a communication connection between the second electronic device and the third electronic device based on the second communication address and the third communication address.

### Seventh Embodiment

In an implementation, the communication between the second electronic device and the third electronic device may be established not only by initiating a communication request from the second electronic device to the third electronic device or by initiating a communication request from the third electronic device to the second electronic device, but the communication between the second electronic device and the third electronic device may also be established by transmitting the obtained second communication address and third communication address from the first electronic device to a fourth electronic device to establish a communication connection between the second electronic device and the third electronic device by the fourth electronic device, thereby achieving the communication forwarding based on the existing communication base station.

In addition, the method may further include, after the obtaining the second communication address of the second electronic device and obtaining the third communication address of the third electronic device in a case where a communication is established between the first electronic device and the second electronic device over a first communication network,

connecting the third electronic device to the first communication network based on the third communication address such that the third electronic device, the second electronic device and the first electronic device are capable of simultaneously connected to the first communication network while the first electronic device keeps communicating.

In an implementation, besides the third electronic device, more electronic devices may be added into the first communication network to achieve multi-party communication. For example, a conference call may be established over the communication network, and new participants may be added in real time.

In addition, the method may further include, after the obtaining the second communication address of the second electronic device and obtaining the third communication address of the third electronic device in a case where the first electronic device communicates with the second electronic device over a first communication channel,

disconnecting the first electronic device from the first communication channel; and

connecting the third electronic device to the first communication channel based on the third communication address such that the third electronic device is capable of communicating with the second electronic device over the first communication channel.

In an implementation, if the conversation between the first electronic device and the second electronic device is forwarded to be between the second electronic device and the third electronic device directly, the third electronic device may use the first communication channel between the first electronic device and the second electronic device, that is, there is no need to establish a new communication channel between the third electronic device and the second electronic device. After the first electronic device is disconnected from the first communication channel, the third electronic device is connected to the first communication channel directly. Therefore, there is no need to search for a new channel, and the speed of establishing a communication connection between the third electronic device and the second electronic device is enhanced.

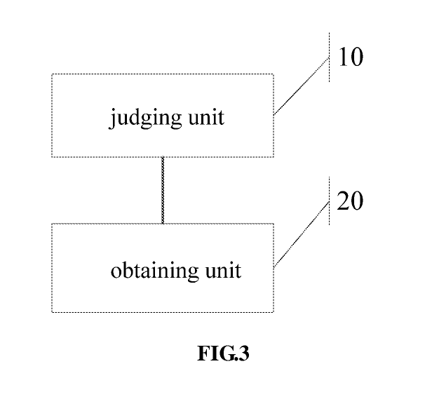

On the basis of the same inventive conception, an information processing device is further provided according to an embodiment of the disclosure. The information processing device is applied to a first electronic device, and the first electronic device is capable of establishing a communication connection with a second electronic device. As shown in FIG. 3, the information processing device includes:

a judging unit 10 adapted to judge whether a communication between the first electronic device and the second electronic device meets a preset condition to obtain a first judgment result; and

an obtaining unit 20 adapted to obtain a second communication address of the second electronic device and obtain a third communication address of a third electronic device in a case where the first judgment result indicates that the communication between the first electronic device and the second electronic device does not meet the preset condition, where the third electronic device is capable of establishing a communication connection with the second electronic device such that a communication connection is capable of being established between the second electronic device and the third electronic device based on the second communication address and/or the third communication address.

Further, the judging unit 10 may include:

a first detection unit adapted to detect whether a current electric quantity of the first electronic device is lower than a threshold to obtain a first detection result; and

a first obtaining sub-unit adapted to obtain the first judgment result based on the first detection result, where in a case where the first detection result indicates that the current electric quantity is lower than the threshold, the first judgment result indicates that the communication between the first electronic device and the second electronic device does not meet the preset condition.

Further, the judging unit 10 may include:

a second detection unit adapted to detect whether a first operation input by a user is obtained in the first electronic device to obtain a second detection result, where the first operation is used to cause the first electronic device to forward the communication connection between the first electronic device and the second electronic device; and

a second obtaining sub-unit adapted to obtain the first judgment result based on the second detection result, where in a case where the second detection result indicates that the first operation is received, the first judgment result indicates that the communication between the first electronic device and the second electronic device does not meet the preset condition.

Further, the obtaining unit 20 may include, in a case where the first electronic device includes a near-field wireless communication module,

a searching unit adapted to search for, by the near-field wireless communication module, the third electronic device whose distance from the first electronic device is less than a preset distance, in a case where the first judgment result indicates that the communication between the first electronic device and the second electronic device does not meet the preset condition; and

a third obtaining sub-unit adapted to establish a paired connection with the third electronic device and obtain a third communication address of the third electronic device after the third electronic device is found.

Further, the obtaining unit 20 may be adapted to:

transmit the third communication address to the second electronic device such that the second electronic device is capable of transmitting a second communication request to the third electronic device based on the third communication address to establish a communication connection with the third electronic device.

Further, the obtaining unit 20 may be adapted to:

transmit the second communication address to the third electronic device such that the third electronic device is capable of transmitting a third communication request to the second electronic device based on the second communication address to establish a communication connection with the second electronic device.

Further, the obtaining unit 20 may be adapted to:

transmit the second communication address and the third communication address to a fourth electronic device such that the fourth electronic device is capable of establishing a communication connection between the second electronic device and the third electronic device based on the second communication address and the third communication address.

Further, the obtaining unit 20 may be adapted to, in a case where a communication is established between the first electronic device and the second electronic device over a first communication network,

connect the third electronic device to the first communication network based on the third communication address such that the third electronic device, the second electronic device and the first electronic device are capable of being simultaneously connected to the first communication network while the first electronic device keeps communicating.

Further, the obtaining unit 20 may include, in a case where the first electronic device communicates with the second electronic device over a first communication channel,

a disconnecting unit adapted to disconnect the first electronic device from the first communication channel; and

a connecting unit adapted to connect the third electronic device to the first communication channel based on the third communication address such that the third electronic device is capable of communicating with the second electronic device over the first communication channel.

There are at least the following technical effects or advantages in the one or more technical solutions of embodiments of the disclosure.

(1) In the embodiment of the disclosure, a target communication address may be obtained on the spot. When it is judged that the communication between the first electronic device and the second electronic device does not meet a preset condition, communication addresses of the second electronic device and the third electronic device may be obtained such that a communication connection is capable of being established between the second electronic device and the third electronic device. In this way, the technical problem that it is unable to flexibly select an object to which the call or the conversation is forwarded in the prior art is solved. In addition, the call forwarding or conversation forwarding may be flexibly performed based on the address selected by the user, whether in the call requesting process or in the conversation process.

(2) In the embodiment of the disclosure, if the communication condition is not met between the first electronic device and the second electronic device, a communication address of a third electronic device in proximity to the first electronic device is obtained in time by a near-field wireless communication module, such that the second electronic device is capable of communicating with the third electronic device based on the communication address of the third electronic device, and the call between first electronic device and the second electronic device is forwarded to be between the second electronic device and the third electronic device. In this way, the technical problem in the existing call forwarding solution that it is unable to obtain in real time an address of a communication device selected by a user to perform the call forwarding or conversation forwarding is solved, and a call may be forwarded to any electronic device selected by the user as desired.

(3) In the embodiment of the disclosure, interaction is provided between the first electronic device and the third electronic device during the call forwarding, and the state of the third electronic device is detected before the third communication address is obtained. In this way, an optimum third electronic device on which the call forwarding or conversation forwarding is capable of being performed may be obtained, and stability and robustness of the communication after the conversation forwarding may be increased.

Those skilled in the art should understand that the embodiment of the disclosure may be embodied as method, system, or computer program product. Accordingly, the disclosure may be in a form of hardware completely, software completely, or a combination of software and hardware. Moreover, the disclosure may be in a form of a computer program product which is implemented on one or more computer usable and installable media (including but not limited to disk device, CD-ROM and optical device) containing computer usable program codes.

The disclosure is described by referring to flow charts and/or block diagrams of a method, a device (system) and a computer program product according to the embodiments of the disclosure. It should be understood that, each flow and/or block in the flow charts and/or block diagrams and combination of flows and/or blocks in the flow charts and/or block diagrams may be implemented by computer program instructions. These computer program instructions may be provided for a general purpose computer, a dedicated computer, an embedded processor or processors of other programmable data processing devices, to produce a machine, such that apparatuses for implementing functions specified in one or more flows of the flow charts and/or one or more blocks of the block diagrams is produced by the instructions executed by a computer or processes of other programmable data processing devices.

These computer program instructions may be stored in a computer readable storage which can conduct a computer or other programmable data processing devices to operate in a special manner, such that the instructions stored in the computer readable storage produce an article including instruction apparatuses, and the instruction apparatuses implement functions specified in one or more flows of the flow charts and/or one or more blocks of the block diagrams.

These computer program instructions may be loaded into a computer or other programmable data processing devices, such that a series of operating steps are performed on the computer or other programmable data processing devices to produce a processing implemented by a computer, thus the instructions executed on the computer or other programmable devices are provided to implement the steps of functions specified in one or more flows of the flow charts and/or one or more blocks of the block diagrams.

Various modifications and variations may be made to the disclosure by those skilled in the art without departing from the spirit and the scope of the disclosure. In this way, if these modifications and variations of the disclosure are within the scope of the claims of the disclosure and equivalents thereof, the disclosure also intends to include these modifications and variations.

1. An information processing method, which is applied to a first electronic device, the first electronic device being capable of establishing a communication connection with a second electronic device, wherein the method comprises:
judging whether a communication between the first electronic device and the second electronic device meets a preset condition to obtain a first judgment result; and
obtaining a second communication address of the second electronic device and obtaining a third communication address of a third electronic device in a case where the first judgment result indicates that the communication between the first electronic device and the second electronic device does not meet the preset condition, wherein the third electronic device is capable of establishing a communication connection with the second electronic device such that a communication connection is capable of being established between the second electronic device and the third electronic device based on the second communication address and/or the third communication address.

2. The method according to claim 1, wherein the judging whether a communication between the first electronic device and the second electronic device meets a preset condition to obtain a first judgment result comprises:
detecting whether a current electric quantity of the first electronic device is lower than a threshold to obtain a first detection result; and
obtaining the first judgment result based on the first detection result, wherein in a case where the first detection result indicates that the current electric quantity is lower than the threshold, the first judgment result indicates that the communication between the first electronic device and the second electronic device does not meet the preset condition.

3. The method according to claim 1, wherein the judging whether a communication between the first electronic device and the second electronic device meets a preset condition to obtain a first judgment result comprises:
detecting whether a first operation input by a user is obtained in the first electronic device to obtain a second detection result, wherein the first operation is used to cause the first electronic device to forward the communication connection between the first electronic device and the second electronic device; and
obtaining the first judgment result based on the second detection result, wherein in a case where the second detection result indicates that the first operation is received, the first judgment result indicates that the communication between the first electronic device and the second electronic device does not meet the preset condition.

4. The method according to claim 1, wherein the first electronic device comprises a near-field wireless communication module, and the obtaining a third communication address of a third electronic device in a case where the communication between the first electronic device and the second electronic device does not meet the preset condition comprises:
searching for, by the near-field wireless communication module, the third electronic device whose distance from the first electronic device is less than a preset distance, in a case where the first judgment result indicates that the communication between the first electronic device and the second electronic device does not meet the preset condition; and
establishing a paired connection with the third electronic device and obtaining the third communication address of the third electronic device after the third electronic device is found.

5. The method according to claim 1, further comprising, after the obtaining a second communication address of the second electronic device and obtaining a third communication address of a third electronic device,
transmitting the third communication address to the second electronic device, such that the second electronic device is capable of transmitting a second communication request to the third electronic device based on the third communication address to establish a communication connection with the third electronic device.

6. The method according to claim 1, further comprising, after the obtaining a second communication address of the second electronic device and obtaining a third communication address of a third electronic device,
transmitting the second communication address to the third electronic device, such that the third electronic device is capable of transmitting a third communication request to the second electronic device based on the second communication address to establish a communication connection with the second electronic device.

7. The method according to claim 1, further comprising, after the obtaining a second communication address of the second electronic device and obtaining a third communication address of a third electronic device,
transmitting the second communication address and the third communication address to a fourth electronic device, such that the fourth electronic device is capable of establishing a communication connection between the second electronic device and the third electronic device based on the second communication address and the third communication address.

8. The method according to claim 1, further comprising, in a case where a communication is established between the first electronic device and the second electronic device over a first communication network and after the obtaining a second communication address of the second electronic device and obtaining a third communication address of a third electronic device,
connecting the third electronic device to the first communication network based on the third communication address, such that the third electronic device, the second electronic device and the first electronic device are capable of being simultaneously connected to the first communication network while the first electronic device keeps communicating.

9. The method according to claim 4, further comprising, in a case where a communication is established between the first electronic device and the second electronic device over a first communication network and after the obtaining a second communication address of the second electronic device and obtaining a third communication address of a third electronic device,
connecting the third electronic device to the first communication network based on the third communication address, such that the third electronic device, the second electronic device and the first electronic device are capable of being simultaneously connected to the first communication network while the first electronic device keeps communicating.

10. The method according to claim 1, further comprising, in a case where the first electronic device communicates with the second electronic device over a first communication channel and after the obtaining a second communication address of the second electronic device and obtaining a third communication address of a third electronic device,
disconnecting the first electronic device from the first communication channel; and
connecting the third electronic device to the first communication channel based on the third communication address, such that the third electronic device is capable of communicating with the second electronic device over the first communication channel.

11. An information processing device, which is applied to a first electronic device, the first electronic device being capable of establishing a communication connection with a second electronic device, wherein the information processing device comprises:
a judging unit, adapted to judge whether a communication between the first electronic device and the second electronic device meets a preset condition to obtain a first judgment result; and
an obtaining unit, adapted to obtain a second communication address of the second electronic device and obtain a third communication address of a third electronic device in a case where the first judgment result indicates that the communication between the first electronic device and the second electronic device does not meet the preset condition, wherein the third electronic device is capable of establishing a communication connection with the second electronic device such that a communication connection is capable of being established between the second electronic device and the third electronic device based on the second communication address and/or the third communication address.

12. The device according to claim 11, wherein the judging unit comprises:
a first detection unit, adapted to detect whether a current electric quantity of the first electronic device is lower than a threshold to obtain a first detection result; and
a first obtaining sub-unit, adapted to obtain the first judgment result based on the first detection result, wherein in a case where the first detection result indicates that the current electric quantity is lower than the threshold, the first judgment result indicates that the communication between the first electronic device and the second electronic device does not meet the preset condition.

13. The device according to claim 11, wherein the judging unit comprises:
a second detection unit, adapted to detect whether a first operation input by a user is obtained in the first electronic device to obtain a second detection result, wherein the first operation is used to cause the first electronic device to forward the communication connection between the first electronic device and the second electronic device; and
a second obtaining sub-unit, adapted to obtain the first judgment result based on the second detection result, wherein in a case where the second detection result indicates that the first operation is received, the first judgment result indicates that the communication between the first electronic device and the second electronic device does not meet the preset condition.

14. The device according to claim 11, wherein the first electronic device comprises a near-field wireless communication module, and the obtaining unit comprises:
a searching unit, adapted to search for, by the near-field wireless communication module, the third electronic device whose distance from the first electronic device is less than a preset distance, in a case where the first judgment result indicates that the communication between the first electronic device and the second electronic device does not meet the preset condition; and
a third obtaining sub-unit, adapted to establish a paired connection with the third electronic device and obtain the third communication address of the third electronic device after the third electronic device is found.

15. The device according to claim 11, wherein the obtaining unit is adapted to:
transmit the third communication address to the second electronic device, such that the second electronic device is capable of transmitting a second communication request to the third electronic device based on the third communication address to establish a communication connection with the third electronic device.

16. The device according to claim 11, wherein the obtaining unit is adapted to:
transmit the second communication address to the third electronic device, such that the third electronic device is capable of transmitting a third communication request to the second electronic device based on the second communication address to establish a communication connection with the second electronic device.

17. The device according to claim 11, wherein the obtaining unit is adapted to:
transmit the second communication address and the third communication address to a fourth electronic device, such that the fourth electronic device is capable of establishing a communication connection between the second electronic device and the third electronic device based on the second communication address and the third communication address.

18. The device according to claim 11, wherein the obtaining unit is adapted to, in a case where a communication is established between the first electronic device and the second electronic device over a first communication network,
connect the third electronic device to the first communication network based on the third communication address, such that the third electronic device, the second electronic device and the first electronic device are capable of being simultaneously connected to the first communication network while the first electronic device keeps communicating.

19. The device according to claim 14, wherein the obtaining unit is adapted to, in a case where a communication is established between the first electronic device and the second electronic device over a first communication network,
connect the third electronic device to the first communication network based on the third communication address, such that the third electronic device, the second electronic device and the first electronic device are capable of being simultaneously connected to the first communication network while the first electronic device keeps communicating.

20. The device according to claim 11, wherein the obtaining unit comprises, in a case where the first electronic device communicates with the second electronic device over a first communication channel,
a disconnecting unit, adapted to disconnect the first electronic device from the first communication channel; and
a connecting unit, adapted to connect the third electronic device to the first communication channel based on the third communication address, such that the third electronic device is capable of communicating with the second electronic device over the first communication channel.
